(19) United States
(12) Patent Application Publication
(10) Pub. No.: US 2005/0051991 A1
(43) Pub. Date: Mar. 10, 2005

(54) Reinforced tractor-trailer slider

(76) Inventors: Nancy L. Saxon, Oakland Township, MI (US); Steven G. Saieg, Sterling Heights, MI (US); Craig Holt, Chesterfield, MI (US); Braden J. Bromley, Royal Oak, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/658,306

(22) Filed: Sep. 9, 2003

(51) Int. Cl. B62D 53/00

(52) U.S. Cl. 280/149.2; 280/407.1

(57) ABSTRACT

This present invention provides a suspension slider assembly for a vehicle trailer comprising first and second spaced apart longitudinal members. A structure having a generally continuous, uniform wall is secured between the longitudinal members. The structure also includes a lateral portion extending between the longitudinal members. The wall includes a central portion adjoining opposing first and second angled portions that extend from the central portion at an angle relative to the lateral portion and longitudinal members.

### BACKGROUND OF THE INVENTION

This invention relates to a reinforced slider frame for a tractor-trailer slider assembly.

Slider assemblies are well known in the trucking industry and are used to reposition the wheels relative to the trailer to redistribute the load on the axles. As is known in the art, damage can occur to the slider during adjustment of the slider relative to the trailer. Specifically, the slider includes a locking pin assembly that cooperates with a series of holes in the trailer frame to lock the slider frame relative to the trailer in a desired position. To adjust the slider assembly relative to the trailer, the pins are unlocked from the trailer and the tractor is driven to move the trailer forward or rearward relative to the slider assembly. The pins are subsequently locked to the trailer. However, the trailer may be driven without the pins fully engaged with the trailer permitting the slider to collide violently with the trailer causing damage to the trailer and/or slider.

A typical slider assembly is shown in FIG. 1. The slider 10 includes a slider frame 12 having a pair of spaced apart longitudinal members 14. Straight lateral members 16 extend between the longitudinal members 14 and are typically secured thereto by welds. Hangers 18 depend from the longitudinal members 14 for supporting suspension assemblies 20. The suspension assemblies 20 support axle assemblies 22. Air springs 24 are arranged between the axle assemblies 22 and are supported by the slider frame 12 on spring seats 25. A single shock absorber 26 is arranged between a lateral member 16 and an axle assembly 22. A locking pin assembly 28 is supported on the slider frame 12 and is actuated to selectively lock and unlock the slider 10 to the trailer.

The arrangement in FIG. 1, like other slider assemblies, may become significantly damaged in the event that the slider assembly collides with the trailer. To limit the damage to the slider frame and increase the structural rigidity of the slider assembly, one prior art configuration has utilized a pair of inclined members secured between the lateral member and the longitudinal members. One terminal end of each inclined member is welded to each longitudinal member, and the opposing terminal ends of the inclined members are welded to the lateral member. Additionally, this prior art slider frame configuration requires the enforcement members welded to the longitudinal members adjacent to the lateral member. However, the addition of the inclined members is insufficient such that the reinforcement members are required adjacent to the lateral members. Therefore, what is needed is an improved slider frame configuration eliminating the need for the reinforcement members while reducing the weld beads required to manufacture the slider frame.

### SUMMARY OF THE INVENTION AND ADVANTAGES

This invention provides a suspension slider assembly for a vehicle trailer comprising first and second spaced apart longitudinal members. In one example, a generally continuous, uniform bent lateral member is secured between the longitudinal members. The bent lateral member includes a central portion adjoining opposing first and second angled portions that extend from the central portion at an angle relative thereto. The first and second angled portions each comprise end portions spaced from the central portion and respectively secured to the first and second longitudinal members. The bent lateral member has a generally continuous vertical wall extending between the end portions and forming at least part of the first and second angled portions and the central portion. In the examples shown, the vertical wall is without welds. The bent member also includes spaced apart generally horizontal walls adjoining the generally continuous wall such that the cross-section of the bent member is C-shaped. In one example, the horizontal walls include notched areas so that the angled portions may be bent toward one another during formation of the bent lateral member. The horizontal wall is joined to itself in the notched area by weld beads. In this manner, the bent lateral member provides increased structural rigidity and reduced welds by bending a generally continuous C-shaped member to form the bent lateral member.

First and second legs are respectively secured between the central portion and the first longitudinal member and the central portion of the second longitudinal member. In one example, the legs are separate pieces. In another example, the first and second legs may be defined by generally continuous straight lateral member to further increase the structural rigidity and reduce weld beads.

The bent lateral members may be arranged in any suitable configuration, for example, the central portions of a pair of bent lateral members may be secured to one another by weld beads, and the end portions of the angled portions of the bent lateral members may be secured to longitudinal members adjacent to lateral members extending between the longitudinal members.

In another example embodiment, the continuous wall may be provided by each of a pair of spaced apart horizontal plates. The plates form the central portion, angled portions, and lateral portion. A vertical member is secured between the horizontal plates, and for the example shown, may form an I-beam structure. Braces may be secured between the lateral portion of the upper plate and the longitudinal members, for example. Portions of the structure interconnecting the longitudinal members may include lightening holes in desirable locations to reduce weight without compromising the structural rigidity of the structure.

Accordingly, the above invention provides an improved slider frame configuration eliminating the need for the reinforcement members while reducing the weld beads required to manufacture the slider frame.

### BRIEF DESCRIPTION OF THE DRAWINGS

Other advantages of this invention can be understood by reference to the following detailed description when considered in connection with the accompanying drawings wherein:

FIG. 1 is a perspective view of a prior art slider assembly;

FIG. 2 is a top elevational view of an example slider frame;

FIG. 3 is a top elevational view of another example slider frame;

FIG. 4 is a top elevational view of yet another example slider frame;

FIG. 5A is a front elevational view of the inventive lateral member prior to bending;

FIG. 5B is a top elevational view of the bent member shown in FIG. 5A after bending;

FIG. 5C is a cross-sectional view of the bent member shown in FIG. 5A taken along line 5C-5C;

FIG. 6 is a perspective view of still another example of the inventive slider frame; and

FIG. 7 is a perspective view of yet another example of the inventive slider frame.

### DETAILED DESCRIPTION OF THE PREFERRED EMBODIMENT

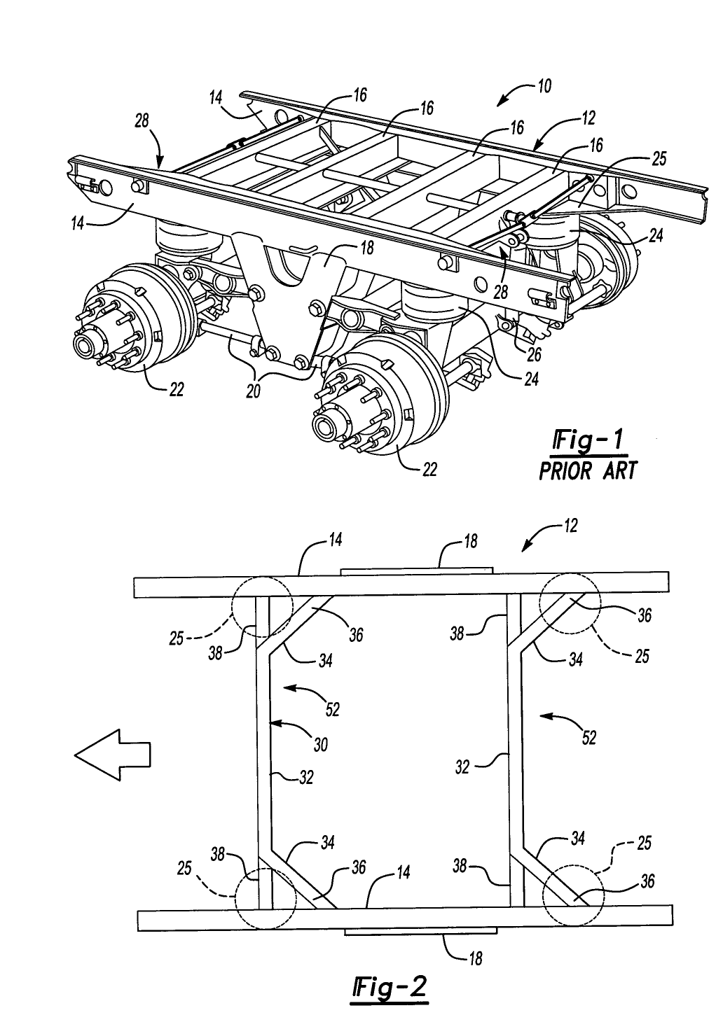

FIG. 1 depicts an exemplary prior art system having a pair of four bar link suspension assemblies 20 supported by hangers 18. Each suspension assembly 20 has a pair of air springs 24 associated with it and a shock absorber 26 extending between an axle 22 of each suspension assembly 20 and the lateral member 16. One of ordinary skill will appreciate that other suspension assembly configurations may be used with the inventive slider frame, as will be described in more detail below.

According to FIG. 2, one example of the inventive bent lateral member 30 is shown extending between the spaced apart longitudinal members 14. Although the front of the slider frame 12 is indicated by the arrow, the slider frame 12 may be oriented differently than shown. The bent lateral member 30 includes a central portion 32 that is generally perpendicular to the longitudinal members 14. A pair of angled portions 34 extend from the central portion 32 at an angle and toward the longitudinal members 14. The bent lateral member 30 includes a pair of opposing end portions 36 that are secured to the longitudinal members 14 by weld beads or other suitable fastening devices.

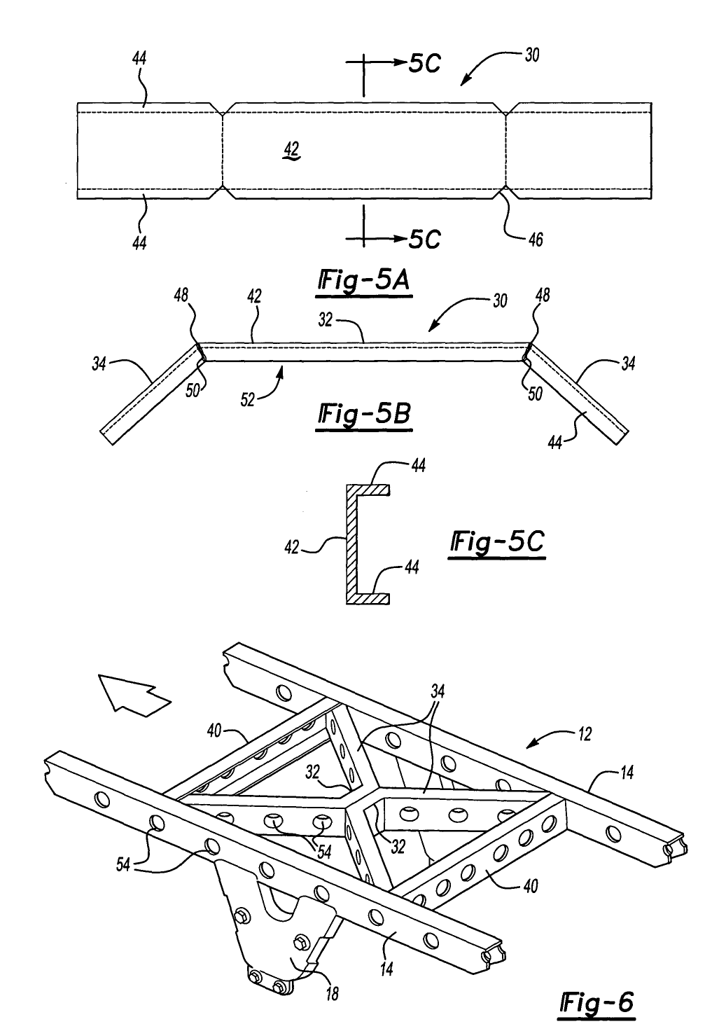

Referring to FIGS. 5A-5C, the bent lateral member 30 of the present invention provides improved structural rigidity over prior art configurations by providing a generally continuous wall 42 extending between the end portions 36. The bent lateral member 30 may include spaced apart generally horizontal walls 44 adjoining the generally vertical continuous wall 42 to form a C-shaped structure, as best shown in FIG. 5C. To provide a continuous bent lateral member 30, the generally horizontal walls 44 have notched areas 46 in the region in which the bent lateral member 30 is bent. The angled portions 34 are bent toward one another such that they each form an intersection 48 with the central portion 32 in the region of the notched area 46. The generally horizontal walls 44 are secured to one another by weld beads 50. In this manner, several vertical welds are eliminated, as used in the prior art, thereby resulting in a stronger structure.

Returning to FIG. 2, legs 38 extend from the central portion 32 and each of the longitudinal members 14. The legs 38, as shown in FIG. 2, may be separate from one another and secured between the bent central 30 and the longitudinal members 14 by weld beads. The spring seats 25 are supported on the slider frame 12 in the area of the legs 38 and/or the bent lateral member 30.

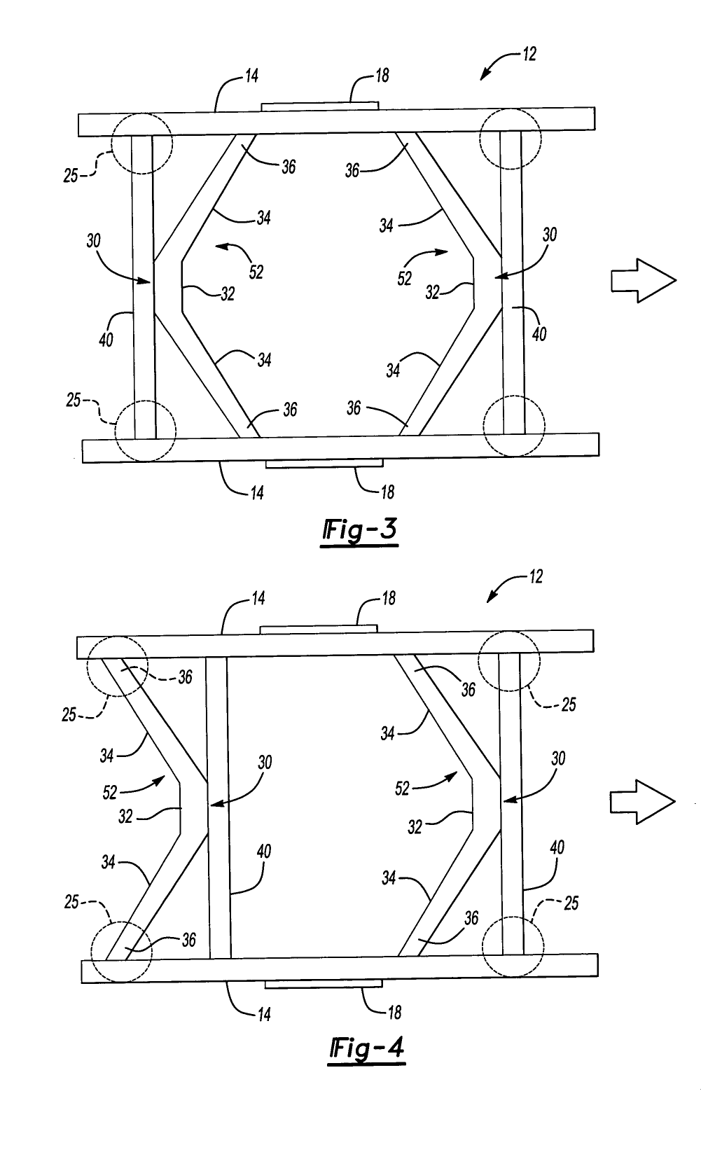

Another example of the inventive slider frame 12 is shown in FIGS. 3 and 4. The bent lateral member 30 shown is more of a V-shape. Furthermore, the legs 38 shown in FIG. 2 are now integrally formed with one another as a continuous straight lateral member 40 extending between the longitudinal members 14 to further reduce weld beads and increase strength. The central portion 32 is secured to the lateral member 40 by weld beads. Securing a continuous lateral member 40 to the central portion 32 of the bent lateral member 30 further improves the structural rigidity of the slider frame 12. The spring seats 25 may be supported on the slider frame 12 in any suitable location, such as in the area of the lateral members 40.

In the case of a bent lateral member 30 formed by a C-shaped structure, the open end of the bent lateral member 30 may be oriented in any desirable manner to facilitate securing the bent lateral member to the lateral member 40, legs 38, and/or the longitudinal members 14. In the example shown in FIG. 2, the open sides 52 of the bent lateral members 30 are facing the rear of the slider frame 12. In the example shown in FIG. 3, the open sides 52 of the bent lateral members 30 are arranged to face one another at the interior of the slider frame 12. In another example shown in FIG. 4, the V-shaped bent lateral members 30, similar to those shown in FIG. 3, may be arranged with the open side 52 facing the rear of the slide frame 12, similar to the arrangement shown in FIG. 2.

Turning now to FIG. 6, another example slider frame 12 is shown. A pair of bent lateral members 30 may be arranged so that the central portions 32 are secured to one another by weld beads. The end portions 36 of the bent lateral members 30 may be secured to a lateral member 40 extending between longitudinal members 14 and/or the longitudinal members 14. The bent lateral members 30 shown in FIG. 6 forms an X-shape and may provide improved structural rigidity by joining the bent lateral members 30 to one another.

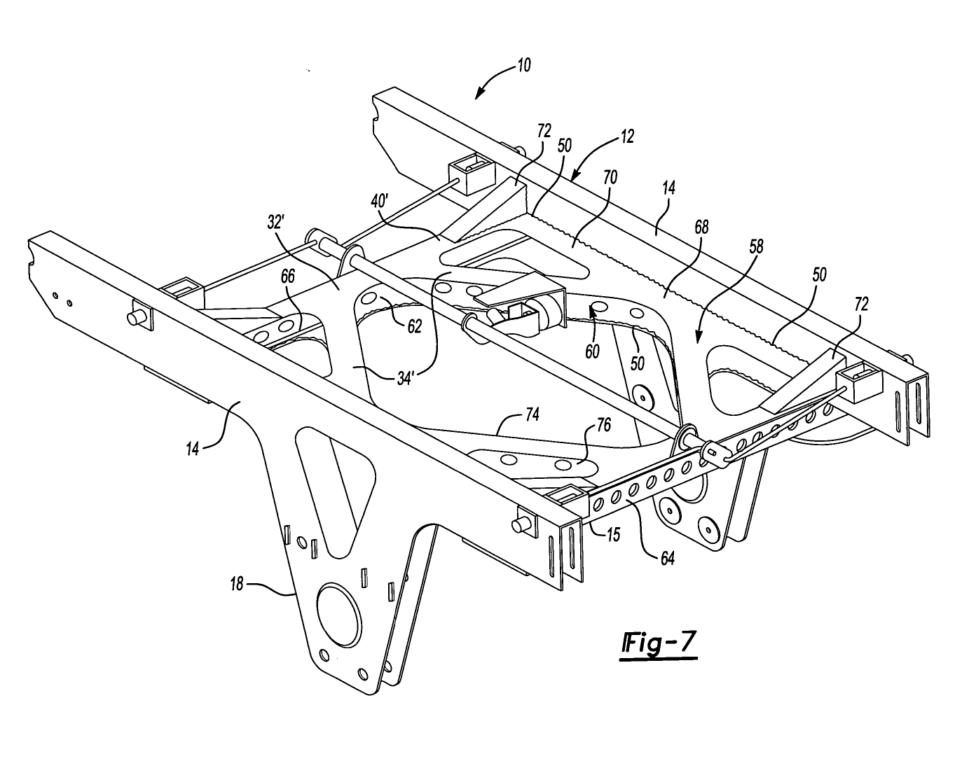

Another example slider frame 12 is shown in FIG. 7. The slider frame 12 includes longitudinal members 14 with a structure 15 interconnecting the longitudinal members 14. The structure 15 may be formed by spaced apart first 58 and second 60 horizontal plates secured to one another by vertical members 62, 64, and 66. The vertical members 62, 64, 66 are secured to the plates 58 and 60 by weld beads 50. The plates 58 and 60 and the vertical members 62, 64, and 66 form an I-beam cross-section in some locations and a C-channel cross-section in other locations for the embodiment shown. The plate 58 and 60 form a continuous wall that defines angled portions 34′ that converge to a central portion 32′. A lateral portion 40′ is also formed as part of the continuous wall and extends in opposing directions from the central portion 42′.

As with the other embodiments, it may be desirable to arrange the lateral portion 40′ generally normal to the longitudinal members 14. The angled portions 34′ are arranged at an angle to both the lateral portions 40′ and the longitudinal members 14.

The structure 15 may also include a second central portion 32′ and pair of angle portions 34′ in addition to another lateral portion 40′. Opposing angled portions 34′ from each pair may converge to a side portion 68. A longitudinal portion 70 may extend between opposing ends from each lateral portion 40′. The longitudinal portions 70 of the structure 15 may be secured to the longitudinal members 14 by a weld bead 50.

Braces 72 may be secured between the structure 15 and the longitudinal member 14 to further increase the structural rigidity of the slider assembly 10. For the embodiment shown in FIG. 7, the braces 72 are secured between the lateral portions 40′ of the plate 58 and the longitudinal members 14 by weld beads 50.

The structure 15 may have any suitable shape. For example, the structure 15 may include a central, diamond-shaped opening 74 with four corner openings 76. Of course, the structure 15 shown in FIG. 7 may be configured as a X-shape, as shown in FIG. 6.

The examples illustrated in the figures provide a slider frame 12 having improved structural rigidity. Furthermore, the need for reinforcement members of the prior art is eliminated and the amount of weld bead required to form the slider frame 12 is reduced. With the improved structural rigidity provided by the inventive slider frame 12, an increased number of lightening holes 54 may be used on the slider frame to reduce the weight of the slider assembly.

As shown in FIG. 6, longitudinal members 14 having a rectangular box cross-section may be used to simplify the attachment of the lateral members 40 and the bent lateral members 30 to the longitudinal members 14 by weld beads. The longitudinal members 14 of FIG. 7 are bent in a U-shaped with the hangers 18 integrally formed with the longitudinal members 14. That is, the hangers 18 and longitudinal members 14 are bent in a U-shape from a single sheet of metal, which enhances the structural rigidity of the longitudinal members 14 and hangers 18.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

1. A suspension slider for a vehicle trailer comprising:
first and second spaced apart longitudinal members;
a bent lateral member having a central portion adjoining opposing first and second angled portions at an angle relative to said central portion, said first and second angled portions each having end portions spaced from said central portion respectively secured to said first and second longitudinal members, said bent lateral member having a generally continuous wall extending between said end portions; and
first and second legs respectively secured between said central portion and said first longitudinal member and said central portion and said second longitudinal member.

2. The slider according to claim 1, wherein said generally continuous wall has a generally uniform thickness.

3. The slider according to claim 2, wherein said bent member includes a C-shaped cross-section.

4. The slider according to claim 3, wherein said C-shaped cross-section defines an open side with said open side facing toward a rearward portion of said slider.

5. The slider according to claim 1, wherein said bent member, legs, and longitudinal members are secured to one another with weld beads.

6. The slider according to claim 1, wherein said central portion is arranged in a direction generally perpendicular to said longitudinal members.

7. The slider according to claim 1, wherein said legs are arranged in a direction generally perpendicular to said longitudinal members.

8. The slider according to claim 1, wherein first and second legs form a generally continuous lateral member extending between said longitudinal members.

9. The slider according to claim 1, wherein said generally continuous wall is unbroken at said bends.

10. The slider according to claim 1, wherein first and second bends in said wall are respectively defined by a first and second intersections respectively at said first angled portion and said central portion and said second angled portion and said central portion

11. The slider according to claim 1, wherein said bent member includes a generally horizontal wall adjoining said generally continuous wall with a weld bead in a notched area of said generally horizontal wall at each intersection.

12. The slider according to claim 1, wherein a pair of said bent lateral members are secured between said longitudinal members with said central portions of said of pair of said bent lateral members are secured to one another forming an X-shape.

13. The slider according to claim 12, wherein said first and second legs forming generally continuous lateral member extending between said longitudinal member with said continuous lateral member extending between said longitudinal members at each of said end portions of said pair of said bent lateral members.

14. A suspension slider for a vehicle trailer comprising:
first and second spaced apart longitudinal members; and
structure interconnecting said first and second longitudinal members, said structure including a continuous wall forming first and second angled portion converging to a central portion, said continuous wall secured to said first and second longitudinal members.

15. The slider according to claim 14, wherein said continuous wall is arranged generally vertical.

16. The slider according to claim 14, wherein said continuous wall is arranged generally horizontal.

17. The slider according to claim 16, wherein said continuous wall is defined by a first plate with a second plate spaced from said plate, and a vertical member secured between said first and second plates.

18. The slider according to claim 16, wherein said continuous wall includes a lateral portion extending in opposing directions from said central portion.

19. The slider according to claim 18, wherein braces are secured between said lateral portions of said plates and said longitudinal members.

20. The slider according to claim 18, wherein said continuous wall includes forming third and fourth angled portion converging to a second central portion, and a second lateral portion extending in opposing directions from said second central portion.
